(19) United States
(12) Patent Application Publication
(10) Pub. No.: US 2024/0298376 A1
(43) Pub. Date: Sep. 5, 2024

(54) SYSTEMS AND METHODS FOR SUCCESSFUL HANDOVER REPORTING

(71) Applicant: ZTE CORPORATION, Shenzhen (CN)

(72) Inventors: Zhuang LIU, Shenzhen (CN); Dapeng LI, Shenzhen (CN); Jiren HAN, Shenzhen (CN); Yin GAO, Shenzhen (CN)

(73) Assignee: ZTE CORPORATION, Shenzhen (CN)

(21) Appl. No.: 18/646,952

(22) Filed: Apr. 26, 2024

Related U.S. Application Data
(63) Continuation of application No. PCT/CN2022/110678, filed on Aug. 5, 2022.

(51) Int. Cl. H04W 76/20; H04W 36/00; H04W 36/32

(52) U.S. Cl. CPC H04W 76/20; H04W 36/00837; H04W 36/324

(57) ABSTRACT

Presented are systems and methods for successful handover reporting. A wireless communication node may receive a first radio resource configuration (RRC) message including: an indication that a successful handover report (SHR) is available at the wireless communication device, and an indication of a type of radio access technology (RAT) associated with the SHR from a wireless communication device. The wireless communication node may receive a second RRC message that comprises: the SHR and first information from the wireless communication device.

### CROSS-REFERENCE TO RELATED APPLICATION

This application claims the benefit of priority under 35 U.S.C. § 120 as a continuation of International Patent Application No. PCT/CN2022/110678, filed on Aug. 5, 2022, the disclosure of which is incorporated herein by reference in its entirety.

### TECHNICAL FIELD

The disclosure relates generally to wireless communications, including but not limited to systems and methods for successful handover reporting.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A wireless communication node (e.g., a NG-RAN node) may receive a first radio resource configuration (RRC) message including: an indication that a successful handover report (SHR) is available (e.g., generated, stored) at the wireless communication device, and an indication of a type of radio access technology (RAT) associated with the SHR from a wireless communication device (e.g., a UE). The wireless communication node may receive a second RRC message that comprises: the SHR and first information from the wireless communication device.

In some embodiments, the first information may comprise at least one of: an indication of the type of RAT associated with the SHR, or second information of at least one node that triggered the SHR, comprising at least one of: a source cell global identity (CGI) of a handover associated with the SHR, a target cell global identity (CGI) of the handover, a source new generation radio access node (NG-RAN) node identifier (ID) or source enhanced nodeB (eNB) ID of the handover, a source tracking area (TA) of the handover, a target NG-RAN node ID or target eNB ID of the handover, a target TA of the handover, a triggered CGI of a cell which configured a trigger condition of the SHR that was met, or a triggered NG-RAN node ID or eNB ID associated with the cell which configured the trigger condition.

In some embodiments, the wireless communication node may determine a first target node to which the SHR is to be transmitted. The first target node can be a source node or a target node of a handover associated with the SHR, or a triggered node associated with a cell which configured a trigger condition of the SHR that was met, according to the second information. The wireless communication node may send an Xn application protocol (XnAP) message to the first target node, the XnAP message comprising at least one of: the SHR, which is in long term evolution (LTE) format, or 5G new radio (NR) format; a source cell radio network temporary identifier (C-RNTI); or mobility information.

In some embodiments, the SHR can be encoded according to a type of RAT of a node that configured at least one condition for triggering the SHR. The wireless communication node may send a new generation application protocol (NGAP) message to a core network (e.g., 5GC), for transmitting the SHR to the first target node through the core network, the NGAP message comprising at least one of: the SHR, which is in long term evolution (LTE) format, or 5G new radio (NR) format; a source cell radio network temporary identifier (C-RNTI); or mobility information. The core network may send to the first target node, at least one NGAP message comprising at least one of: the SHR, which is in LTE format, or 5G NR format; the C-RNTI; or the mobility information.

In some embodiments, the wireless communication node or the first target node may comprise a centralized unit (CU). The CU may send to a distributed unit (DU) of the wireless communication node or the first target node, a F1 application protocol (F1AP) message comprising at least one of: the SHR, which is in LTE format, or 5G NR format; the C-RNTI; or the mobility information. The wireless communication node may send an X2 application protocol (X2AP) message to the first target node, the X2AP message comprising at least one of: the SHR, which is in long term evolution (LTE) format, or 5G new radio (NR) format; a source cell radio network temporary identifier (C-RNTI); or mobility information.

In some embodiments, the wireless communication node may send a S1 application protocol (S1AP) message to a first core network of long term evolution (LTE), for transmitting the SHR to the first target node through the first core network and a second core network (e.g., 5GC), the S1AP message comprising at least one of: the SHR, which is in long term evolution (LTE) format, or 5G new radio (NR) format; a source cell radio network temporary identifier (C-RNTI); or mobility information. The second core network may send a new generation application protocol (NGAP) message to the first target node, the NGAP message comprising at least one of: the SHR, which is in LTE format, or 5G NR format; the C-RNTI; or the mobility information.

In some embodiments, a wireless communication device (e.g., a UE) may send a first radio resource configuration (RRC) message including: an indication that a successful handover report (SHR) is available at the wireless communication device, and an indication of a type of radio access technology (RAT) associated with the SHR to a wireless communication node (e.g., a NG-RAN node). The wireless communication device may send a second RRC message that comprises: the SHR and first information to the wireless communication node.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a sequence diagram for successful handover reporting, in accordance with some embodiments of the present disclosure;

FIG. 4 illustrates a sequence diagram for successful handover reporting, in accordance with some embodiments of the present disclosure;

FIG. 5 illustrates a sequence diagram for successful handover reporting, in accordance with some embodiments of the present disclosure;

FIG. 6 illustrates a sequence diagram for successful handover reporting, in accordance with some embodiments of the present disclosure;

FIG. 7 illustrates a sequence diagram for successful handover reporting, in accordance with some embodiments of the present disclosure; and

FIG. 8 illustrates a flow diagram for successful handover reporting, in accordance with an embodiment of the present disclosure.

### DETAILED DESCRIPTION

### 1. Mobile Communication Technology and Environment

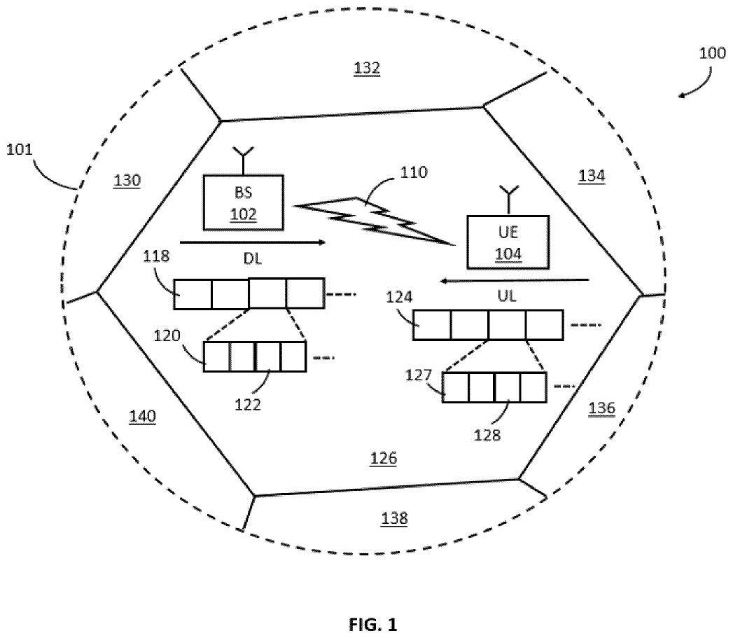

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

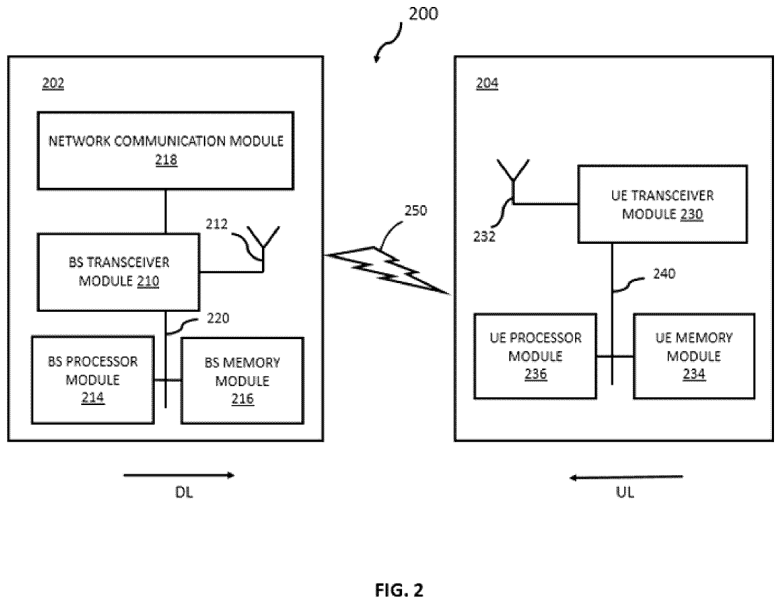

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (cNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also cach include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Successful Handover Reporting

For a successful hangover (HO) from a gNB, which belongs to a source new radio (NR) (e.g., 5G new radio) cell, to a ng-eNB, which belongs to a target long term evolution (LTE) cell, or a successful HO from a ng-eNB, which belongs to a source LTE cell, to a gNB, which belongs to a target 5G NR cell, a UE may not generate a LTE format successful handover report (SHR). If eNB configured SHR triggering condition(s) are met, a SHR receiving NG-RAN node may not deliver a LTE format SHR to an associated node of the handover (e.g., a source/target node) for mobility robustness optimization.

In 5G/6G/other networks, one function of mobility robustness optimization is to detect underlying connection failures during successful ordinary handovers. Problems for successful handover (HO) can be defined as follows. During the successful handovers, some successful handover report (SHR) triggering condition(s) can be met, which means some problems may happen during the handovers.

For the successful HO from a source NR (e.g., 5G new radio) cell to a target NR cell, a network can configure SHR triggering condition(s) to a UE before a coming handover. If the configured SHR triggering condition(s) have been met upon the successful handover procedure with the target cell, the UE may generate a successful handover report (SHR). The UE may store a latest (or most recent) successful handover report until the successful handover report is fetched/requested by the network or for 48 hours after the successful handover report is generated. The UE may indicate the availability of a successful handover report, and the network may fetch/request the successful handover report from the UE.

The SHR may be delivered to a node where a triggered triggering condition is configured. That is, if the SHR is triggered by at least one of the triggering condition(s) configured by the source node, the SHR may be delivered to the source node of the handover. Otherwise, the SHR may be delivered to the target node of the handover. Consequently, the corresponding node can perform the optimization based on the received SHR report.

In current 5G network, a UE may only generate a SHR for a successful HO from a NG-RAN Node 1 belonging to a source 5G NR cell to a NG-RAN Node 2 belonging to a target 5G NR cell. In other words, only 5G NR intra-radio access technology (RAT) SHR may be supported in current 5G network.

In a 5G/6G/other network, a next-generation RAN (NG-RAN) node may either be a gNB or a next-generation evolved Node B (ng-eNB). The gNB may provide services of 5G NR RAT user plane and control plane toward the UE. The ng-eNB may provide services of LTE RAT user plane and control plane protocol toward the UE. The gNB(s) and ng-eNB(s) can be inter-connected with each other by means of (via) an Xn interface, while they can be connected to the 5GC by means of (via) a NG interfaces.

### Implementation Example 1 (Intra-5GC): Previous Inter-RAT SHR Reporting via Xn Interface

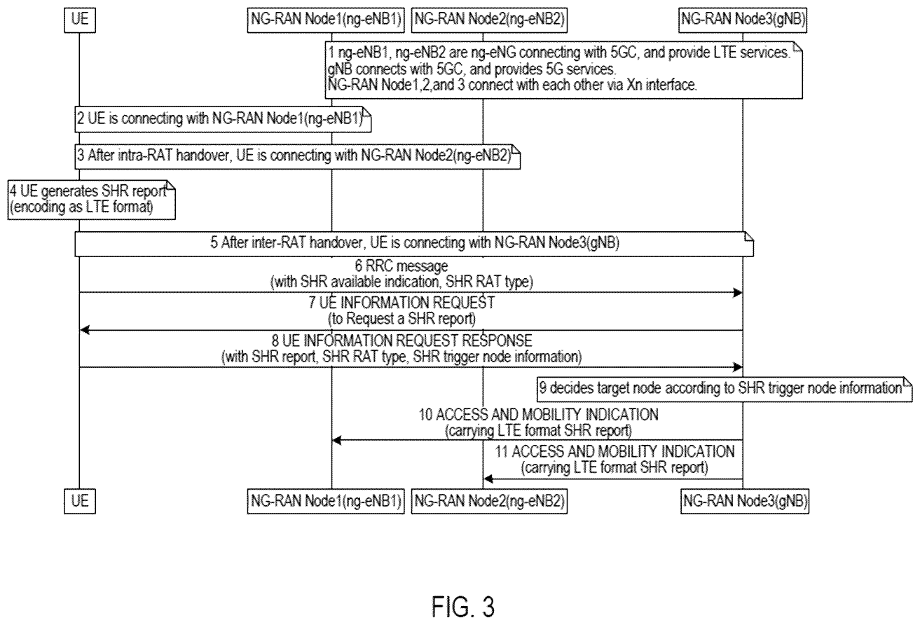

In this implementation example, a previous a LTE RAT handover may have occurred. A UE may generate a successful handover report (SHR) based on a RAT type (e.g., LTE format SHR). However, the network may not (immediately) fetch the LTE SHR from the UE. After some period of time, the UE may successfully handover to the gNB, and the gNB may (at that time) fetch/request the previous SHR from the UE. The network may deliver the LTE SHR to a source/target ng-eNB associated with the HO SHR. FIG. 3 illustrates an example message flows and interactions between the UE, the ng-eNB(s), and the gNB.

In step 1, an ng-eNB can be an enhanced LTE eNodeB that connects to a 5G Core network (5GC). eNB1 and eNB2 can each be an ng-eNB. gNB may connect with the 5G Core network. gNBs and ng-eNBs can be inter-connected with each other by means of (or via) an Xn interface.

In step 2, a UE may be connecting with a NG-RAN Node 1 (e.g., ng-eNB 1) providing LTE RAT services.

In step 3, after an intra-RAT (e.g., LTE to LTE) handover, the UE can be connecting with NG-RAN Node 2 (e.g., ng-NB 2) providing LTE RAT services.

In step 4, the UE may generate a successful handover report (SHR) which can be encoded based on a RAT type of a node which configures corresponding trigger condition(s) that are met. All SHR trigger condition(s) can be configured by ng-eNB 1 and/or ng-eNB 2. The UE may generate a LTE format SHR.

In step 5, after an inter-RAT (e.g., LTE to 5G NR) handover, the UE can handover from the ng-eNB 1 to a gNB. The UE can be connecting with (e.g., can be connected to/with) a NG-RAN Node 3 (e.g., gNB) providing 5G NR RAT services. In some embodiments, there may be no SHR trigger condition(s) that are met during the handover. Therefore, there is no new SHR generated by the UE.

In step 6, the UE can send a RRC message (e.g., a RRC setup request, a RRC reconfiguration request response, a RRC resume request, and/or a RRC Reestablishment request response) to the NG-RAN Node 3 (e.g., gNB) to inform that there is a SHR available at the UE. The RRC message may comprise a SHR RAT type indication (e.g., LTE type, or 5G NR type).

In step 7, the NG-RAN Node 3 (e.g., gNB) may send a RRC message (e.g., a UE Information request) to the UE to fetch/request the SHR.

In step 8, the UE may send a RRC message (e.g., a UE Information request response) to the NG-RAN Node 3 (e.g., gNB). The RRC message may comprise a SHR report (in a LTE SHR format). At least one of the following information may be included in the RRC message: an indication of LTE type RAT associated with the SHR, or second information of at least one node that triggered the SHR, comprising at least one of: a source cell global identity (CGI) of a handover associated with the SHR, a target cell global identity (CGI) of the handover, a source new generation radio access node (NG-RAN) node identifier (ID) or source enhanced nodeB (cNB) ID of the handover, a source tracking area (TA) of the handover, a target NG-RAN node ID or target eNB ID of the handover, a target TA of the handover, a triggered CGI of a cell which configured a trigger condition of the SHR that was met, or a triggered NG-RAN node ID or eNB ID associated with the cell which configured the trigger condition. The CGI can be a NR CGI or a LTE CGI. The TA of the handover is to uniquely identify a tracking area.

In step 9, the NG-RAN Node 3 (e.g., gNB) may decide/determine the target node to which the SHR is to be transmitted according to the SHR trigger node information. The target node can be a source node or a target node of a handover associated with the SHR. In certain embodiments, the target node can be a triggered node associated a cell which configured a trigger condition of the SHR that was met.

In step 10, the NG-RAN Node 3 (e.g., gNB) may send an XnAP message (e.g., access and mobility indication) to a target node (e.g., source NG-RAN Node (ng-eNB 1)) of the handover associated with the SHR. The XnAP message may comprise a LTE format SHR.

In step 11, the NG-RAN Node 3 (e.g., gNB) may send an XnAP message (e.g., access and mobility information) to a target node (e.g., target NG-RAN Node (ng-eNB 2)) of the handover associated with the SHR. The XnAP message may comprise a LTE format SHR.

### Implementation Example 2 (Intra-5GC): Current Inter-RAT SHR Reporting via Xn Interface

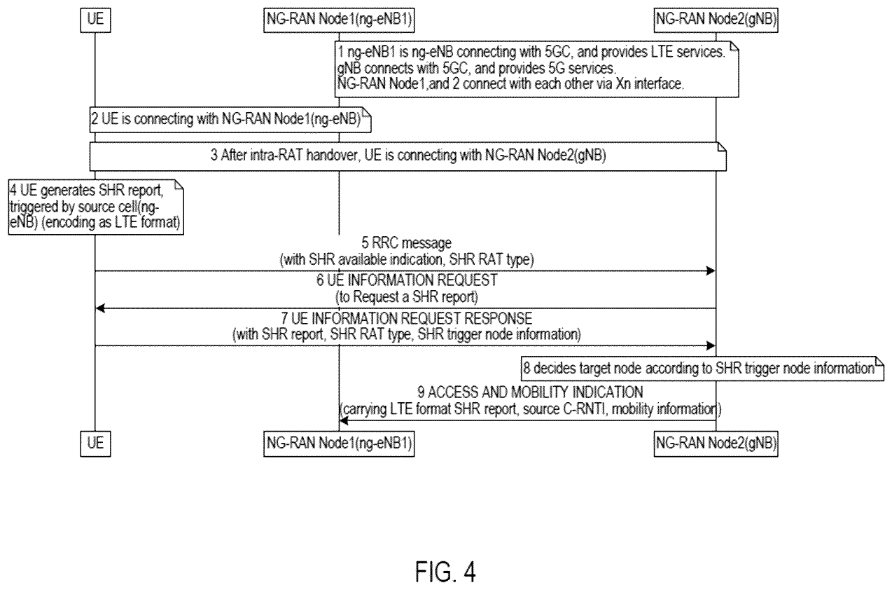

In this implementation example, a current handover between a LTE RAT and a 5G NR RAT may have occurred. A UE may generate a successful handover report (SHR) which is encoded based on a RAT type of a node which configures corresponding met SHR trigger condition(s). In some embodiments, a UE may generate a LTE format SHR. The gNB (e.g, target node of the handover) may fetch/request the current SHR from the UE. The gNB may deliver the LTE SHR to a source ng-eNB of the handover. FIG. 4 illustrates example message flows and interactions between the UE, the ng-eNB, and the gNB.

In step 1, an NG-RAN Node 1 (e.g., eNB) can be ng-eNB connecting with a 5G core network (5GC), and may provide LTE services. An NG-RAN Node 2 (e.g., gNB) may connect with the 5GC, and may provide 5G services. The NG-RAN Node 1, NG-RAN Node 2 connects with each other via an Xn interface.

In step 2, a UE can be connecting with the NG-RAN Node 1(e.g., ng-eNB 1) providing LTE RAT services.

In step 3, after an inter-RAT (e.g., LTE to 5G NR) handover, the UE can be connecting with a NG-RAN Node 2 (e.g., gNB) providing 5G NR RAT services.

In step 4, the UE may generate a successful handover report (SHR) which can be encoded based on a RAT type of a node which configures corresponding triggering condition(s). The UE may generate a LTE format SHR. In some embodiments, if the gNB configured SHR triggering condition is met, the UE may generate a 5G NR format SHR.

In step 5, the UE can send a RRC message (e.g., a RRC setup request, a RRC reconfiguration request response, a RRC resume request, and/or a RRC Reestablishment request response) to the NG-RAN node 2 (e.g., gNB) to inform that there is a SHR available at UE. The RRC message may comprise a SHR RAT type indication (e.g., LTE type, or 5G NR type).

In step 6, the NG-RAN Node 2 (e.g., gNB) may send a RRC message (e.g., a UE Information request) to the UE to fetch/request the SHR.

In step 7, the UE may send a RRC message (e.g., a UE Information request response) to the NG-RAN Node 2 (e.g., gNB). The RRC message may comprise a SHR report (in LTE SHR format). At least one of the following information may include in the RRC message: an indication of LTE type RAT associated with the SHR, or second information of at least one node that triggered the SHR, comprising at least one of: a source cell global identity (CGI) of a handover associated with the SHR, a target cell global identity (CGI) of the handover, a source new generation radio access node (NG-RAN) node identifier (ID) or source enhanced nodeB (cNB) ID of the handover, a source tracking area (TA) of the handover, a target NG-RAN node ID or target eNB ID of the handover, a target TA of the handover, a triggered CGI of a cell which configured a trigger condition of the SHR that was met, or a triggered NG-RAN node ID or eNB ID associated with the cell which configured the trigger condition. The CGI can be a NR CGI or a LTE CGI. The TA of the handover is to uniquely identify a tracking arca.

In step 8, the NG-RAN Node 2 (e.g., gNB) can be the target node of the handover. The gNB can decide/determine a target node to which the SHR is to be transmitted according to received SHR trigger node information. The target node can be a source node or a target node of a handover associated with the SHR. In some embodiments, the gNB may decide/determine a source node of handover based on a UE context. If the target node (e.g., gNB) keeps the UE context, the gNB may find out a source cell radio network temporary identifier (C-RNTI) (to identify the UE in the source node) and/or mobility information in a handover request message.

In step 9, the NG-RAN Node 2 (e.g., gNB) may send an XnAP message (e.g., access and mobility information) to a source NG-RAN Node (e.g., ng-eNB) of the handover associated the SHR. The XnAP message may comprise at least one of the following information in the XnAP message: the SHR, which is in long term evolution (LTE) format, or 5G new radio (NR) format; a source cell radio network temporary identifier (C-RNTI); or mobility information. If the UE generated SHR is 5G NR format in step 4, the SHR format here can be 5G NR format. The source C-RNTI may identify the UE in the source node/cell. The mobility information may assist the source node to identify the sub-optimal mobility parameters and to perform the possible adjustments.

### Implementation Example 3 (Intra-5GC): Current Inter-RAT SHR Reporting via 5GC NG Interface (without Xn Interface)

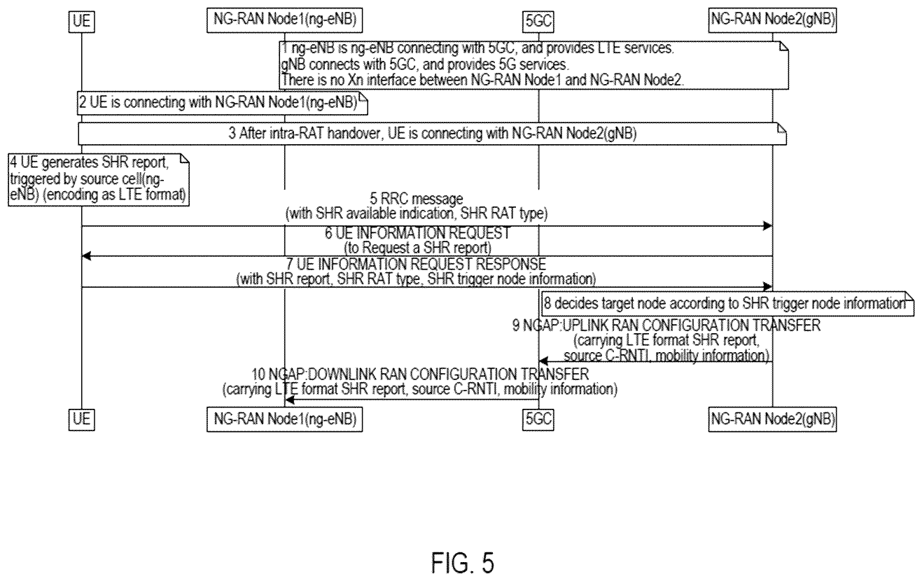

In this implementation example, a current handover between a LTE RAT and a 5G NR RAT may be occurred. A UE may generate a successful handover report (SHR) which is encoded based on a RAT type of a node which configures corresponding met SHR trigger condition(s). In some embodiments, a UE may generate a LTE format SHR. The NG-RAN Node 1 (e.g., target node of the handover) may fetch/request the current SHR from the UE. The NG-RAN Node 1 may deliver the LTE SHR to a NG-RAN Node2 (e.g., source node of the handover associated with the SHR). In some embodiments, there may be no Xn interface between the NG-RAN Node 1 and the NG-RAN Node 2. The NG-RAN Node 1 (e.g., a target node of the handover) may deliver the SHR to the NG-RAN Node 2 (e.g., a source node of the handover associated with the SHR) via a 5G core network (5GC). FIG. 5 illustrates example message flows and interactions between the UE, the NG-RAN nodes, and the 5GC.

In step 1, a NG-RAN Node 1 may provide RAT type 1 services (e.g., LTE services). A NG-RAN Node 2 may provide RAT type 2 services (e.g., 5G NR services). The NG-RAN Node 1 and 2 may connect with 5GC. In certain embodiments, there may be no Xn interface between the NG-RAN Node 1 and the NG-RAN Node 2.

In step 2, a UE can be connecting with the NG-RAN Node 1 (e.g., ng-eNB 1) providing LTE RAT services.

In step 3, after an inter-RAT (e.g., LTE to 5G NR) handovers via a NG interface, the UE can be connecting with the NG-RAN Node 2 (e.g., gNB) providing 5G NR RAT services.

In step 4, the UE may generate a successful handover report (SHR) which can be encoded based on a RAT type of a node which configures corresponding triggering condition(s). In some embodiments, if the ng-gNB configured SHR triggering condition is met, the UE may generate/output a LTE NR format SHR. In certain embodiments, if the gNB configured SHR triggering condition is met, the UE may generate a 5G NR format SHR.

In step 5, the UE may send a RRC message (e.g., a RRC setup request, a RRC reconfiguration request response, a RRC resume request, and/or a RRC Reestablishment request response) to a NG-RAN node 2 (e.g., gNB) to inform that there is a SHR available at the UE. The RRC message may comprise a SHR RAT type indication (e.g., LTE type, or 5G NR type).

In step 6, the NG-RAN Node 2 (e.g., gNB) may send a RRC message (e.g., a UE Information request) to the UE to fetch/request the SHR.

In step 7, the UE may send a RRC message (e.g., a UE Information request response) to the NG-RAN Node 2 (e.g., gNB). The RRC message may comprise a SHR report (in LTE SHR format). At least one of the following information may include in the RRC message: an indication of LTE type RAT associated with the SHR, or second information of at least one node that triggered the SHR, comprising at least one of: a source cell global identity (CGI) of a handover associated with the SHR, a target cell global identity (CGI) of the handover, a source new generation radio access node (NG-RAN) node identifier (ID) or source enhanced nodeB (eNB) ID of the handover, a source tracking area (TA) of the handover, a target NG-RAN node ID or target eNB ID of the handover, a target TA of the handover, a triggered CGI of a cell which configured a trigger condition of the SHR that was met, or a triggered NG-RAN node ID or eNB ID associated with the cell which configured the trigger condition. The CGI can be a NR CGI or a LTE CGI. The TA of the handover is to uniquely identify a tracking area.

In step 8, the NG-RAN Node 2 (e.g., gNB) can be a target node of the handover. The gNB can may decide/determine a target node to which the SHR is to be transmitted according to received SHR trigger node information. The target node can be a source node or a target node of a handover associated with the SHR. In some embodiments, the gNB may decide/determine a source node of handover based on a UE context. If the target node (e.g., gNB) keeps the UE context, the gNB may find out a source cell radio network temporary identifier (C-RNTI) (to identify the UE in the source node) and/or mobility information in a handover request message.

In step 9, since there is no Xn interface between the source node and the target node, the NG-RAN Node may transfer the SHR to the source node of handover associated with the SHR via a 5GC. The NG-RAN Node 2 (e.g., gNB) may send a new generation application protocol (NGAP) message (e.g., an uplink RAN configuration transfer) to the 5GC. The NGAP message may comprise at least one of the following: the SHR, which is in long term evolution (LTE) format, or 5G new radio (NR) format; a source cell radio network temporary identifier (C-RNTI); or mobility information. If the UE generated SHR is of a 5G NR format in step 4, the SHR format here can be 5G NR format. The source C-RNTI may identify the UE in the source node/cell. The mobility information may assist the source node to identify the sub-optimal mobility parameters and to perform the possible adjustments.

In step 10, the 5GC may send a NGAP message (e.g., a downlink RAN configuration transfer) to the NG-RAN Node 1 (e.g., ng-eNB). The NGAP message may comprise at least one of the following: the SHR, which is in long term evolution (LTE) format, or 5G new radio (NR) format; a source cell radio network temporary identifier (C-RNTI); or mobility information. If the UE generated SHR is 5G NR format in step 4, the SHR format here can be 5G NR format. The source C-RNTI may identify the UE in the source node/cell. The mobility information may assist the source node to identify the sub-optimal mobility parameters and to perform the possible adjustments.

### Implementation Example 4: SHR Reporting via F1 Interface (CU/DU Case)

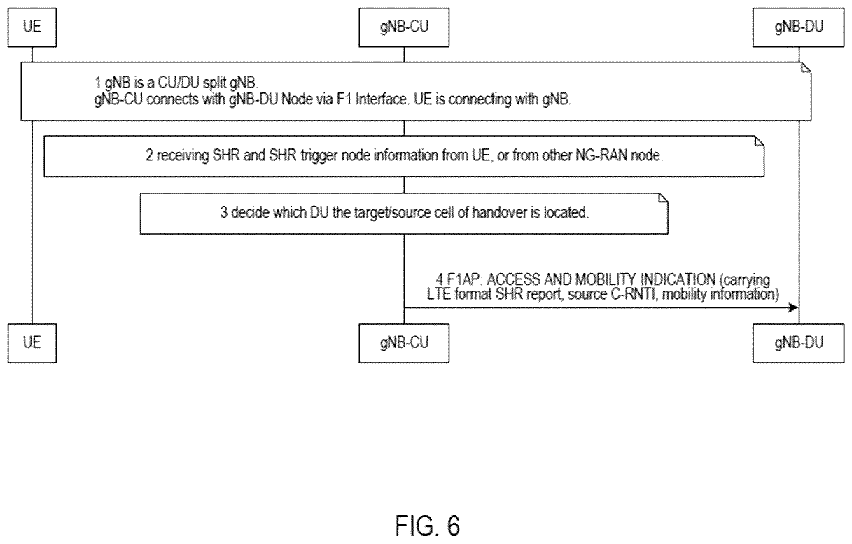

In this implementation example, a gNB-centralized unit (CU) may deliver a successful handover report (SHR) to a gNB-distributed unit (DU) on which a source cell or target cell is located. FIG. 6 illustrates example message flows and interactions between the UE, the gNB-CU, and the gNB-DU.

In step 1, a gNB can be a CU/DU split gNB. The gNB-CU may connect with the gNB-DU node via a F1 Interface. A UE can be connecting with the gNB.

In step 2, the gNB (e.g., gNB-CU) may receive a SHR and/or SHR trigger node information from the UE, or from other NG-RAN node.

In step 3, the gNB-CU may decide/determine which gNB-DU the source cell or target cell of handover associated with the SHR is located based on the received SHR trigger node information, or based on a kept UE context. If the target node (e.g., gNB) keeps the UE context, the gNB-CU may find out a source cell radio network temporary identifier (C-RNTI) (to identify the UE in the source node) and/or mobility information in a handover request message.

In step 4, the gNB-CU may send a F1AP message (e.g., access and mobility indication) to the gNB-DU. The F1AP may comprise at least one of the following: the SHR, which is in long term evolution (LTE) format, or 5G new radio (NR) format; a source cell radio network temporary identifier (C-RNTI); or mobility information. The source C-RNTI may identify the UE in the source node/cell. The mobility information may assist the source node to identify the sub-optimal mobility parameters and to perform the possible adjustments.

### Implementation Example 5: eNB (LTE Node) Delivers SHR to NG-RAN Node

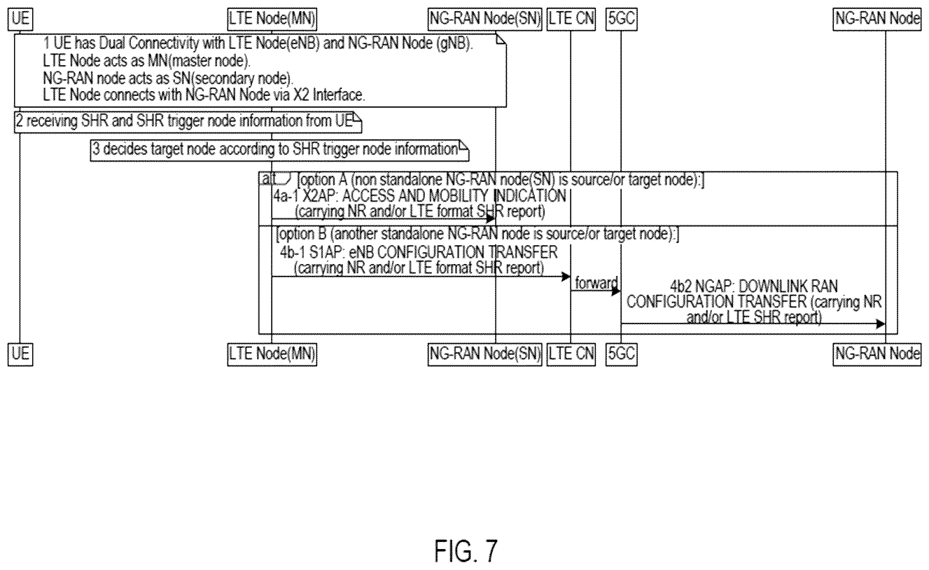

FIG. 7 illustrates example message flows and interactions between a UE, a LTE node, NG-RAN nodes, a LTE core network, and a 5GC.

In step 1, a UE may have dual connectivity with a LTE node (e.g., eNB) and a NG-RAN node (e.g., gNB). The LTE node may act as a master node (MN). The NG-RAN node may act as a secondary node (SN). The LTE node may connect with the NG-RAN Node (e.g., gNB) via an X2 Interface.

In step 2, the LTE node (e.g., eNB) may receive a SHR and/or SHR trigger node information from the UE.

In step 3, the LTE node may decide/determine a first target node to which the SHR is to be transmitted according to received SHR trigger node information. The first target node can be a source node or a target node of a handover associated with the SHR. In some embodiments, the first target node can be a triggered node associated the cell which configures the SHR trigger condition(s) that are met.

### Condition A: Non-Standalone NG-RAN Node (SN) is Source or Target Node

In step 4a-1, if the SN is the target node, the eNB/MN may send a X2AP message (e.g., access and mobility indication) to the NG-RAN node (e.g., SN). The X2AP may comprise at least one of the following: the SHR, which is in long term evolution (LTE) format, or 5G new radio (NR) format; a source cell radio network temporary identifier (C-RNTI); or mobility information. The source C-RNTI may identify the UE in the source node/cell. The mobility information may assist the source node to identify the sub-optimal mobility parameters and/or to perform the possible adjustments.

### Condition B: Another Standalone NG-RAN Node is Source or Target Node

In step 4b-1, if another standalone NG-RAN Node is the target node, the eNB may transfer the SHR to the NG-RAN Node via a LTE core network and a 5GC. The eNB may send a SIAP message to the LTE core network (e.g., eNB configuration transfer), and to the 5GC. The SIAP message may comprise at least one of the following: the SHR, which is in long term evolution (LTE) format, or 5G new radio (NR) format; a source cell radio network temporary identifier (C-RNTI); or mobility information. The source C-RNTI may identify the UE in the source node/cell. The mobility information may assist the source node to identify the sub-optimal mobility parameters and to perform the possible adjustments. The LTE core network may forward the received information to the 5GC via a S1AP message.

In step 4b-2, the 5GC may send a NGAP message (e.g., a downlink RAN configuration transfer) to a NG-RAN node. The NGAP message may comprise at least one of the following: the SHR, which is in long term evolution (LTE) format, or 5G new radio (NR) format; a source cell radio network temporary identifier (C-RNTI); or mobility information. The source C-RNTI may identify the UE in the source node/cell. The mobility information may assist the source node to identify the sub-optimal mobility parameters and to perform the possible adjustments.

It should be understood that one or more features from the above implementation examples are not exclusive to the specific implementation examples, but can be combined in any manner (e.g., in any priority and/or order, concurrently or otherwise).

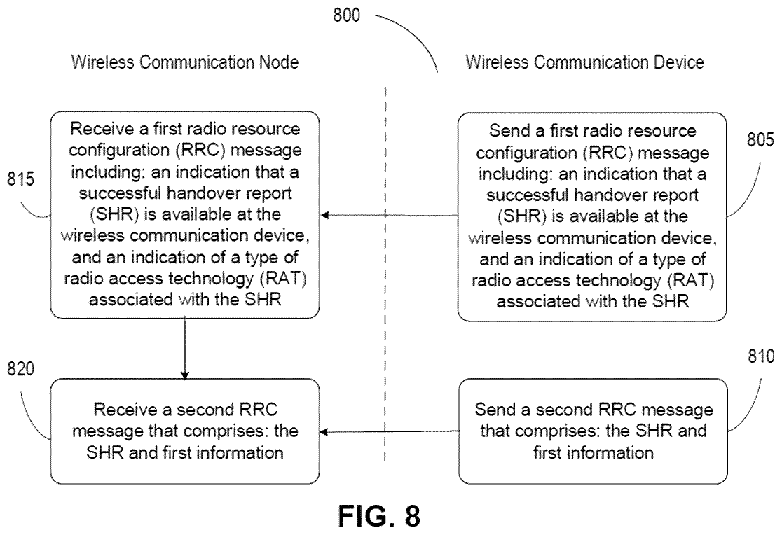

FIG. 8 illustrates a flow diagram of a method 800 for successful handover reporting. The method 800 may be implemented using any one or more of the components and devices detailed herein in conjunction with FIGS. 1-2. In overview, the method 800 may be performed by a wireless communication node, in some embodiments. Additional, fewer, or different operations may be performed in the method 800 depending on the embodiment. At least one aspect of the operations is directed to a system, method, apparatus, or a computer-readable medium.

A wireless communication node (e.g., a NG-RAN node) may receive a first radio resource configuration (RRC) message including: an indication that a successful handover report (SHR) is available at the wireless communication device, and/or an indication of a type of radio access technology (RAT) associated with the SHR from a wireless communication device (e.g., a UE). The wireless communication node may receive a second RRC message that comprises: the SHR and/or first information from the wireless communication device.

In some embodiments, the first information may comprise at least one of: an indication of the type of RAT associated with the SHR, or second information of at least one node that triggered the SHR, comprising at least one of: a source cell global identity (CGI) of a handover associated with the SHR, a target cell global identity (CGI) of the handover, a source new generation radio access node (NG-RAN) node identifier (ID) or source enhanced nodeB (eNB) ID of the handover, a source tracking area (TA) of the handover, a target NG-RAN node ID or target eNB ID of the handover, a target TA of the handover, a triggered CGI of a cell which configured a trigger condition of the SHR that was met, or a triggered NG-RAN node ID or eNB ID associated with the cell which configured the trigger condition.

In some embodiments, the wireless communication node may determine a first target node to which the SHR is to be transmitted. The first target node can be a source node or a target node of a handover associated with the SHR, or a triggered node associated with a cell which configured a trigger condition of the SHR that was met, according to the second information. The wireless communication node may send an Xn application protocol (XnAP) message to the first target node, the XnAP message comprising at least one of: the SHR, which is in long term evolution (LTE) format, or 5G new radio (NR) format; a source cell radio network temporary identifier (C-RNTI); or mobility information.

In some embodiments, the SHR can be encoded according to a type of RAT of a node that configured at least one condition for triggering the SHR. The wireless communication node may send a new generation application protocol (NGAP) message to a core network, for transmitting the SHR to the first target node through the core network. The NGAP message may comprise at least one of: the SHR, which is in long term evolution (LTE) format, or 5G new radio (NR) format; a source cell radio network temporary identifier (C-RNTI); or mobility information. The core network may send to the first target node, at least one NGAP message comprising at least one of: the SHR, which is in LTE format, or 5G NR format; the C-RNTI; or the mobility information.

In some embodiments, the wireless communication node or the first target node may comprise a centralized unit (CU). The CU may send to a distributed unit (DU) of the wireless communication node or the first target node, a F1 application protocol (F1AP) message comprising at least one of: the SHR, which is in LTE format, or 5G NR format; the C-RNTI; or the mobility information. The wireless communication node may send an X2 application protocol (X2AP) message to the first target node. The X2AP message may comprise at least one of: the SHR, which is in long term evolution (LTE) format, or 5G new radio (NR) format; a source cell radio network temporary identifier (C-RNTI); or mobility information.

In some embodiments, the wireless communication node may send a S1 application protocol (S1AP) message to a first core network of long term evolution (LTE), for transmitting the SHR to the first target node through the first core network and a second core network. The S1AP message can comprise at least one of: the SHR, which is in long term evolution (LTE) format, or 5G new radio (NR) format; a source cell radio network temporary identifier (C-RNTI); or mobility information. The second core network may send a new generation application protocol (NGAP) message to the first target node, the NGAP message comprising at least one of: the SHR, which is in LTE format, or 5G NR format; the C-RNTI; or the mobility information.

In some embodiments, a wireless communication device (e.g., a UE) may send a first radio resource configuration (RRC) message including: an indication that a successful handover report (SHR) is available at the wireless communication device, and an indication of a type of radio access technology (RAT) associated with the SHR to a wireless communication node (e.g., a NG-RAN node). The wireless communication device may send a second RRC message that comprises: the SHR and first information to the wireless communication node.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
receiving, by a wireless communication node from a wireless communication device, a first radio resource configuration (RRC) message including: an indication that a successful handover report (SHR) is available at the wireless communication device, and an indication of a type of radio access technology (RAT) associated with the SHR; and
receiving, by the wireless communication node from the wireless communication device, a second RRC message that comprises: the SHR and first information.

2. The method of claim 1, wherein the first information comprises at least one of:
an indication of the type of RAT associated with the SHR, or
second information of at least one node that triggered the SHR, comprising at least one of:
a source cell global identity (CGI) of a handover associated with the SHR, a target cell global identity (CGI) of the handover, a source new generation radio access node (NG-RAN) node identifier (ID) or source enhanced nodeB (eNB) ID of the handover, a source tracking area (TA) of the handover, a target NG-RAN node ID or target eNB ID of the handover, a target TA of the handover, a triggered CGI of a cell which configured a trigger condition of the SHR that was met, or a triggered NG-RAN node ID or eNB ID associated with the cell which configured the trigger condition.

3. The method of claim 1, comprising determining, by the wireless communication node, a first target node to which the SHR is to be transmitted,
wherein the first target node is a source node or a target node of a handover associated with the SHR, or a triggered node associated with a cell which configured a trigger condition of the SHR that was met, according to the second information.

4. The method of claim 3, comprising sending, by the wireless communication node, an Xn application protocol (XnAP) message to the first target node, the XnAP message comprising at least one of:
the SHR, which is in long term evolution (LTE) format, or 5G new radio (NR) format;
a source cell radio network temporary identifier (C-RNTI); or
mobility information.

5. The method of claim 1, wherein the SHR is encoded according to a type of RAT of a node that configured at least one condition for triggering the SHR.

6. The method of claim 3, comprising sending, by the wireless communication node, a new generation application protocol (NGAP) message to a core network, for transmitting the SHR to the first target node through the core network, the NGAP message comprising at least one of:
the SHR, which is in long term evolution (LTE) format, or 5G new radio (NR) format;
a source cell radio network temporary identifier (C-RNTI); or
mobility information.

7. The method of claim 6, wherein the core network sends to the first target node, at least one NGAP message comprising at least one of:
the SHR, which is in LTE format, or 5G NR format;
the C-RNTI; or
the mobility information.

8. The method of claim 1, wherein the wireless communication node or the first target node comprises a centralized unit (CU), and the CU sends to a distributed unit (DU) of the wireless communication node or the first target node, a F1 application protocol (F1AP) message comprising at least one of:
the SHR, which is in LTE format, or 5G NR format;
the C-RNTI; or
the mobility information.

9. The method of claim 3, comprising:
sending, by the wireless communication node, an X2 application protocol (X2AP) message to the first target node, the X2AP message comprising at least one of:
the SHR, which is in long term evolution (LTE) format, or 5G new radio (NR) format;
a source cell radio network temporary identifier (C-RNTI); or
mobility information.

10. The method of claim 3, comprising:
sending, by the wireless communication node, a S1 application protocol (S1AP) message to a first core network of long term evolution (LTE), for transmitting the SHR to the first target node through the first core network and a second core network, the S1AP message comprising at least one of:
the SHR, which is in long term evolution (LTE) format, or 5G new radio (NR) format;
a source cell radio network temporary identifier (C-RNTI); or
mobility information.

11. The method of claim 10, wherein the second core network sends a new generation application protocol (NGAP) message to the first target node, the NGAP message comprising at least one of:
the SHR, which is in LTE format, or 5G NR format;
the C-RNTI; or
the mobility information.

12. A method, comprising:
sending, by a wireless communication device to a wireless communication node, a first radio resource configuration (RRC) message including: an indication that a successful handover report (SHR) is available at the wireless communication device, and an indication of a type of radio access technology (RAT) associated with the SHR; and
sending, by the wireless communication device to the wireless communication node, a second RRC message that comprises: the SHR and first information.

13. A wireless communication device, comprising:
at least one processor configured to:
send, via a transmitter to a wireless communication node, a first radio resource configuration (RRC) message including: an indication that a successful handover report (SHR) is available at the wireless communication device, and an indication of a type of radio access technology (RAT) associated with the SHR; and
send, via the transmitter to the wireless communication node, a second RRC message that comprises: the SHR and first information.

14. A wireless communication node, comprising:
at least one processor configured to:
receive, via a receiver from a wireless communication device, a first radio resource configuration (RRC) message including: an indication that a successful handover report (SHR) is available at the wireless communication device, and an indication of a type of radio access technology (RAT) associated with the SHR; and
receive, via the receiver from the wireless communication device, a second RRC message that comprises: the SHR and first information.

15. The wireless communication node of claim 14, wherein the first information comprises at least one of:
an indication of the type of RAT associated with the SHR, or
second information of at least one node that triggered the SHR, comprising at least one of:
a source cell global identity (CGI) of a handover associated with the SHR, a target cell global identity (CGI) of the handover, a source new generation radio access node (NG-RAN) node identifier (ID) or source enhanced nodeB (eNB) ID of the handover, a source tracking area (TA) of the handover, a target NG-RAN node ID or target eNB ID of the handover, a target TA of the handover, a triggered CGI of a cell which configured a trigger condition of the SHR that was met, or a triggered NG-RAN node ID or eNB ID associated with the cell which configured the trigger condition.

16. The wireless communication node of claim 14, wherein the at least one processor configured to determine a first target node to which the SHR is to be transmitted,
wherein the first target node is a source node or a target node of a handover associated with the SHR, or a triggered node associated with a cell which configured a trigger condition of the SHR that was met, according to the second information.

17. The wireless communication node of claim 16, wherein the at least one processor configured to send, via a transmitter, an Xn application protocol (XnAP) message to the first target node, the XnAP message comprising at least one of:
the SHR, which is in long term evolution (LTE) format, or 5G new radio (NR) format;
a source cell radio network temporary identifier (C-RNTI); or
mobility information.

18. The wireless communication node of claim 14, wherein the SHR is encoded according to a type of RAT of a node that configured at least one condition for triggering the SHR.

19. The wireless communication node of claim 16, wherein the at least one processor configured to send, via a transmitter, a new generation application protocol (NGAP) message to a core network, for transmitting the SHR to the first target node through the core network, the NGAP message comprising at least one of:
the SHR, which is in long term evolution (LTE) format, or 5G new radio (NR) format;
a source cell radio network temporary identifier (C-RNTI); or
mobility information.

20. The wireless communication node of claim 19, wherein the core network sends to the first target node, at least one NGAP message comprising at least one of:
the SHR, which is in LTE format, or 5G NR format;
the C-RNTI; or
the mobility information.
